(19) United States
(12) Patent Application Publication
(10) Pub. No.: US 2012/0322028 A1
(43) Pub. Date: Dec. 20, 2012

(54) DENTAL SYRINGE

(76) Inventors: JOSHUA JAMES CHEETHAM, WINDSOR (AU); PAUL JAMES FARRAR, BOX HILL NORTH (AU)

(21) Appl. No.: 13/523,929

(22) Filed: Jun. 15, 2012

(30) Foreign Application Priority Data
Jun. 17, 2011 (AU) 2011902376

(51) Int. Cl. A61C 19/00

(52) U.S. Cl. 433/90

(57) ABSTRACT

A dental syringe including a hollow piston having threads on the inner wall thereof, and an exterior threaded rod disposable within the hollow piston and upon rotation of the rod moving the piston longitudinally for dispensing dental material from the syringe.

### FIELD OF THE INVENTION

The present invention relates to a dental syringe

### SUMMARY OF THE INVENTION

In accordance with one aspect of the present invention there is provided a dental syringe characterized by comprising an outer body having a first end and a second outer end, the outer body containing an elongated hollow section having mounted therein a non-axially rotatable elongated piston, an axially rotatable member being mounted at the first end of the hollow section, the piston containing an axially extending elongated recess which is internally threaded and having a closed end and an opposed open end, an externally threaded rod being connected to the axially rotatable member and being threadedly engaged with the recess contained in the piston, the arrangement being such that axial rotation of the rotatable member is able to cause the piston to move into the hollow section such that dental material contained in the hollow section between the piston and the second end is dispensed from the second outlet end of the outer body.

### DESCRIPTION OF THE DRAWINGS

The present invention will now be described, by way of example, with reference to the accompanying drawings, in which:

FIG. 1a is a perspective view of a dental syringe in accordance with the present invention;

FIG. 1b is a view similar to FIG. 1a with a cap removed;

FIG. 2 is a perspective view of the syringe of FIGS. 1a and 1b in disassembled condition;

FIG. 3a is a longitudinal sectional exploded view similar to FIG. 2 of the dental syringe of FIGS. 1 and 2;

FIG. 3b is a longitudinal assembled sectional view of the dental syringe of FIG. 3a;

FIG. 3c is a view similar to FIG. 3b showing the dental syringe in activated condition.

### DETAILED DESCRIPTION OF THE INVENTION

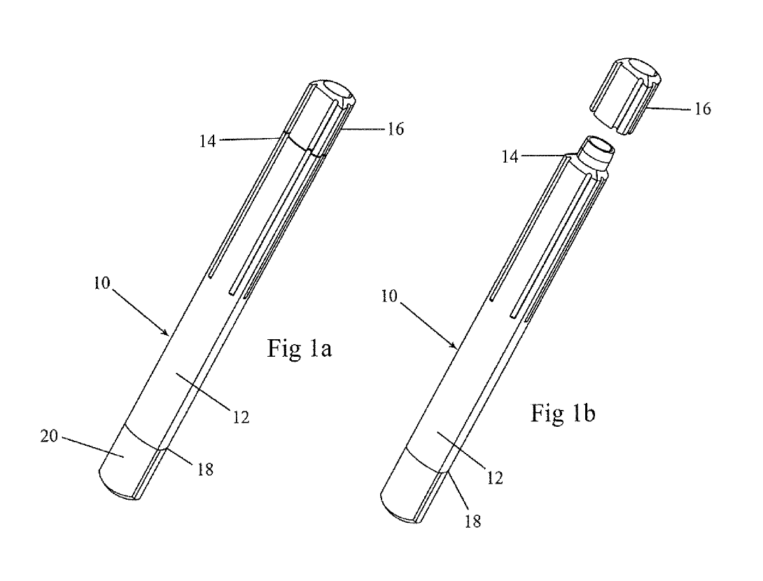

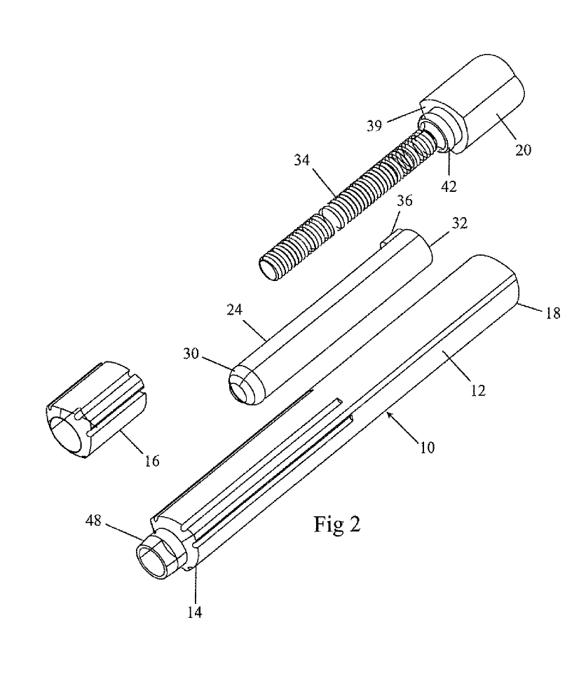

In FIGS. 1a and 1b and 2 of the accompanying drawings there is shown a dental syringe 10 for dispensing dental material comprising an elongated body 12. The elongated body 12 has a first outlet end 14 having mounted thereto a removable end cap 16 and a second end 18 having mounted thereto an axially rotatable member 20.

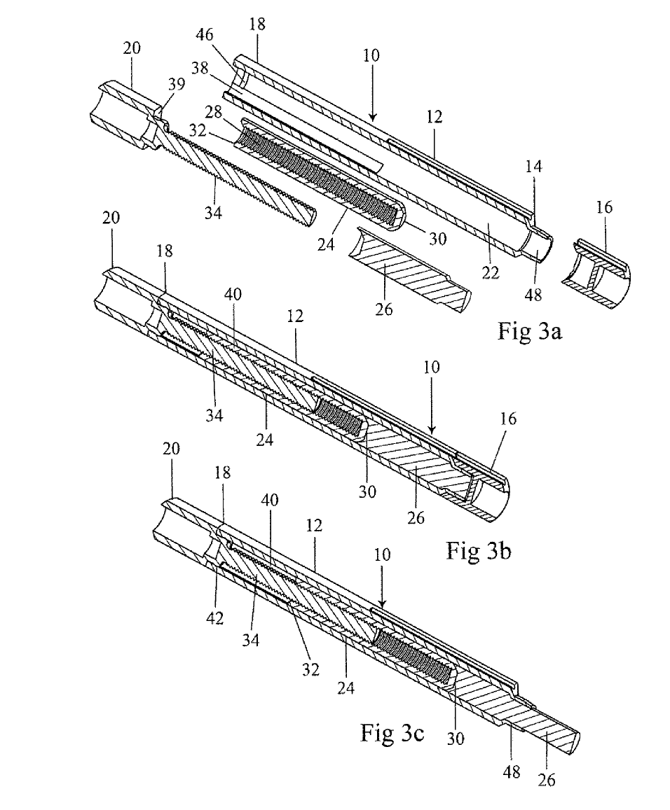

The elongated body 12 contains an elongated hollow section 22 best seen in FIG. 3a, in which is mounted a non-axially rotatable elongated piston 24. During assembly the hollow section 22 is partially filled with dental material 26 at the outlet end 14 thereof adjacent the end cap 16. The piston 24 is then inserted into the hollow section 22 as shown in FIG. 3b abutting the dental material 26.

As can be seen in FIG. 3a the piston 24 contains an axially extending recess 28 which is internally threaded. The piston 24 also has a closed end 30 and an opposed open end 32.

The apparatus 10 further comprises an externally threaded rod 34 which is connected to the rotatable member 20.

The piston 24 contains one or more external raised sections 36 (see FIG. 2) which engage with an elongated internal recess 38 in the body 12 (see FIG. 3a).

The externally threaded rod 34 is arranged to be threadedly engaged with the internally threaded recess 28 of the piston 24.

Subsequent to insertion of the piston 24 into the body 12, the threaded rod 34 is threadedly engaged with the piston 24. The rod 34 is rotated by rotation of the rotatable member 20 until an inner end 39 of rotatable member 20 engages with the end 18 of the body 12. In this position, as shown in FIG. 3b, the inner end 30 of the piston 24 is in engagement with the dental material 26. Further, it can be seen that there is an annular gap 40 between the open end 32 of the piston 24 and the end 18 of the body 12.

Further, it can be seen in FIG. 2 that the rotatable member 20 has a ring 42 mounted near the inner end 39 thereof adjacent to the outer body 12. The ring 42 engages with the end 18 of the outer body 12 in the position shown in FIG. 3b so as to retain the rotatable member 20 in position. In fact, the ring 42 is shaped to engage with an internal circumferential groove 46 within the end 18 of the outer body 12 as shown in FIGS. 3a and 3b.

It can also be seen that the end 14 of the body 12 has an outlet portion 48 of reduced internal cross section compared to the remainder of the hollow section 22 of the body 12.

In use, the rotatable member 20 is axially rotated as the inner end 39 engages with the end 18 of the body 12.

Subsequently the rotatable member 20 may be rotated so as to cause the piston 24 to move further into the body 12 or to move towards the end 18 of the body 12. This is achieved by variation of the direction of rotation of the member 20 and the threaded engagement of the rod 34 with the recess 28.

To eject the dental material from the syringe 10, the removable end cap 16 has to be removed. Then the piston 24 is urged towards the end 14 by the above described rotation of the rod 34. As shown in FIG. 3c this causes the dental material 26 to be dispensed through the outlet 48. The dental material 26 is in this way made available for use by a dentist.

The outlet 48 could alternatively have an outlet of the same size as the hollow section 22. The syringe 10 shown in the drawings is not circular in external shape but it could conveniently be made in a circular shape if desired.

Modifications and variations as would be apparent to a skilled addressee are deemed to be within the scope of the present invention.

1. A dental syringe comprising an outer body having a first end and a second outer end, the outer body containing an elongated hollow section having mounted therein a non-axially rotatable elongated piston, an axially rotatable member being mounted at the first end of the hollow section, the piston containing an axially extending elongated recess which is internally threaded and having a closed end and an opposed open end, an externally threaded rod being connected to the axially rotatable member and being threadedly engaged with the recess contained in the piston, the arrangement being such that axial rotation of the rotatable member is able to cause the piston to move into the hollow section such that dental material contained in the hollow section between the piston and the second end is dispensed from the second outlet end of the outer body.

2. A dental syringe according to claim 1, wherein the piston is shaped to engage with the body to inhibit axial rotation of the piston.

3. A dental syringe according to claim 2, wherein the piston has at least one raised section arranged to engage with a corresponding internal elongated recess in the body.

4. A dental syringe according to claim 1, wherein the axially rotatable member is shaped to engage with the first end of the hollow section.

5. A dental syringe according to claim 4, wherein the axially rotatable member has a ring mounted thereto adjacent the outer body.

6. A dental syringe according to claim 4, wherein the axially rotatable member has a ring member adjacent the outer body and the outer body has an internal circumferential groove adjacent the first end thereof, the groove being arranged to engage with the ring member of the axially rotatable member.

7. A dental syringe according to claim 1, wherein the second outlet end has an outlet portion of reduced internal cross sectional dimension.

8. A dental syringe according to claim 1, wherein the second outlet end is provided with a removable end cap.

9. A dental syringe according to claim 1, wherein there is an annular gap between the open end of the piston and the first end of the outer body when the axially rotatable member is engaged with the first end of the hollow section.

10. A dental syringe according to claim 1, wherein the syringe contains dental material.
